(19) United States
(12) Patent Application Publication
(10) Pub. No.: US 2007/0117420 A1
(43) Pub. Date: May 24, 2007

(54) Holder

(75) Inventor: Kousuke Kinoshita, Kosai-shi (JP)

Correspondence Address: SUGHRUE-265550, 2100 PENNSYLVANIA AVE. NW, WASHINGTON, DC, 20037-3213, US

(73) Assignee: YAZAKI CORPORATION

(21) Appl. No.: 11/589,228

(22) Filed: Oct. 30, 2006

(30) Foreign Application Priority Data
Nov. 22, 2005 (JP) P2005-336698

(51) Int. Cl. H01R 12/00

(52) U.S. Cl. 439/76.2

(57) ABSTRACT

There is provided a holder 3 for holding an electric connection box 2 and for fixing the electric connection box 2 to a vehicle body. The holder includes at least two positioning portions 13 and 16 for positioning the electric connection box 2, and an interconnecting portion 14 interconnecting the two positioning portions 13 and 16, and the two positioning portions 13 and 16 and the interconnecting portion 14 are formed integrally with one another, using a synthetic resin.

### BACKGROUND OF THE INVENTION

1. Field of the Invention

This invention relates to a holder by which an electric connection box for mounting on an automobile or the like serving as a mobile body is fixed to a vehicle body.

2. Description of the Related Art

Generally, various electronic equipments, including lamps (such as headlamps and tail lamps) and motors (such as a starter motor and an air conditioner motor), are mounted on an automobile serving as a mobile body.

Junction boxes have been located at suitable regions in the automobile in order to supply electric power to the above various electronic equipments. The junction block is formed by combining various electric circuit units of many fuses, relays, etc., together.

Such a junction block often includes fuses, relays, bus bars or others, and therefore is often called a fuse block or a relay box, or is generically called an electric connection box. In the present specification, the fuse block, the relay box and the junction block will hereinafter be referred to generically as “an electric connection box”.

The above electric connection box has been prepared according the kind of car. Namely, the electric connection boxes of different designs have been provided respectively for different kinds of cars. However, in recent years, it has been proposed to provide common electric connection boxes to be used for the various cars in order to reduce the cost of the cars. In order to use the common electric connection boxes for the various cars, it has been proposed to provide holders of different designs respectively for different kinds of cars, and the holder is attached to the electric connection box, and then the holder is mounted on a vehicle body or the like of the automobile. It can be proposed to use a conventional known bolt to fix the electric connection box to the holder.

However, the above holder was made of metal, and therefore positioning portions of the holder for positioning the electric connection box relative to the holder could not be formed into a complicated shape, and it was difficult to accurately position the electric connection box, so that the electric connection box could not be stably fixed. And besides, the holder was shaped, taking into consideration the shape of a mounting portion thereof for mounting on the vehicle body, and therefore it was difficult to form the accurate positioning portions at the holder.

### SUMMARY OF THE INVENTION

It is therefore an object of the invention to provide a holder in which positioning portions of a complicated shape can be formed.

The above object has been achieved by a holder of the invention of claim 1 for holding an electric connection box and for fixing the electric connection box to a vehicle body; characterized in that the holder includes at least two positioning portions for positioning the electric connection box, and an interconnecting portion interconnecting the two positioning portions; and the two positioning portions and the interconnecting portion are formed integrally with one another, using a synthetic resin.

In the holder of the invention of claim 1, at least two positioning portions and the interconnecting portion are formed integrally with one another, using the synthetic resin, and therefore the electric connection box is mounted on the holder in such a manner that the electric connection box is positioned by the positioning portions which are shaped, taking the configuration of the electric connection box, the position of fixing of the holder to the vehicle body, etc., into consideration.

The holder of the invention of claim 2, depending from claim 1, is characterized in that the positioning portion includes a reception portion against which a projecting portion projecting from the electric connection box is adapted to abut, and an abutment portion against which an edge portion of the electric connection box is adapted to abut.

In the holder of the invention of claim 2, the reception portion and the abutment portion are formed at the positioning portion, and therefore the projecting portion is brought into abutting engagement with the reception portion of the positioning portion, and also the edge portion of the electric connection box is brought into abutting engagement with the abutment portion, and by doing so, the electric connection box can be mounted on the holder in such a manner that the electric connection box is positioned relative to the holder.

The holder of the invention of claim 3, depending from claim 1 or claim 2, is characterized in that the interconnecting portion has a mounting portion to which another electric connection box is attached.

In the holder of the invention of claim 3, the interconnecting portion has the mounting portion to which the other electric connection box is attached, and therefore in addition to the electric connection box mounted on the holder, the other electric connection box is mounted on the interconnecting portion.

As described above, in the holder of the invention of claim 1, at least two positioning portions and the interconnecting portion are formed integrally with one another, using the synthetic resin, and therefore there can be provided the positioning portions which are shaped, taking the configuration of the electric connection box, the position of fixing of the holder to the vehicle body, etc., into consideration. Therefore, the complicated positioning portions can be formed, so that the electric connection box can be stably fixed. And besides, when the positioning portions are formed according to the kind of car, the common electric connection box can be used for various cars. Furthermore, even when the positioning portions for the electric connection box are formed separately from a mounting portion for mounting on the vehicle body so that the holder can be used as a mounting conversion member for mounting the electric connection box on the vehicle body, the electric connection box can be stably fixed to the vehicle body.

In the invention of claim 2, in addition to the advantages of the invention of claim 1, the reception portion and the abutment portion are formed at the positioning portion, and therefore the projecting portion and the edge portion of the electric connection box are brought into abutting engagement with the reception portion and the abutment portion of the holder, respectively, and by doing so, the positioning of the electric connection box can be effected. Therefore, the operation for positioning the electric connection box relative to the holder can be easily carried out, so that the efficiency of the operation can be enhanced.

In the invention of claim 3, in addition to the advantages of the invention of claims 1 and 2, the interconnecting portion has the mounting portion to which the other electric connection box is attached, and therefore in addition to the electric connection box, the other electric connection box can be mounted on the holder, and therefore it is not necessary to consider the position of mounting of the other electric connection box relative to the vehicle body, and the plurality of electric connection boxes can be fixed to the vehicle body by the holder.

### BRIEF DESCRIPTION OF THE DRAWINGS

FIG. 1 is a perspective view of one preferred embodiment of an electric connection unit of the present invention.

FIG. 2 is an exploded, perspective view of the electric connection unit of FIG. 1.

FIG. 3 is a perspective view of the electric connection unit of FIG. 1, showing the opposite side thereof.

FIG. 4 is a perspective view showing a condition in which a small-size electric connection box is removed from the electric connection unit of FIG. 3.

FIG. 5 is a view showing a condition before an electric connection box is positioned relative to a holder.

FIG. 6 is an enlarged view showing a portion A of FIG. 5.

FIG. 7 is a view showing a condition in which the electric connection box is positioned relative to the holder.

FIG. 8 is an enlarged view of a portion B of FIG. 7.

FIG. 9 is a fragmentary, enlarged schematic view showing a modified positioning portion of a holder.

FIG. 10 is a view showing the manner of mounting an electric connection box on the holder of FIG. 9.

FIG. 11 is a fragmentary enlarged view showing a condition in which the electric connection box is positioned relative to the holder of FIG. 10.

### DESCRIPTION OF THE PREFERRED EMBODIMENTS

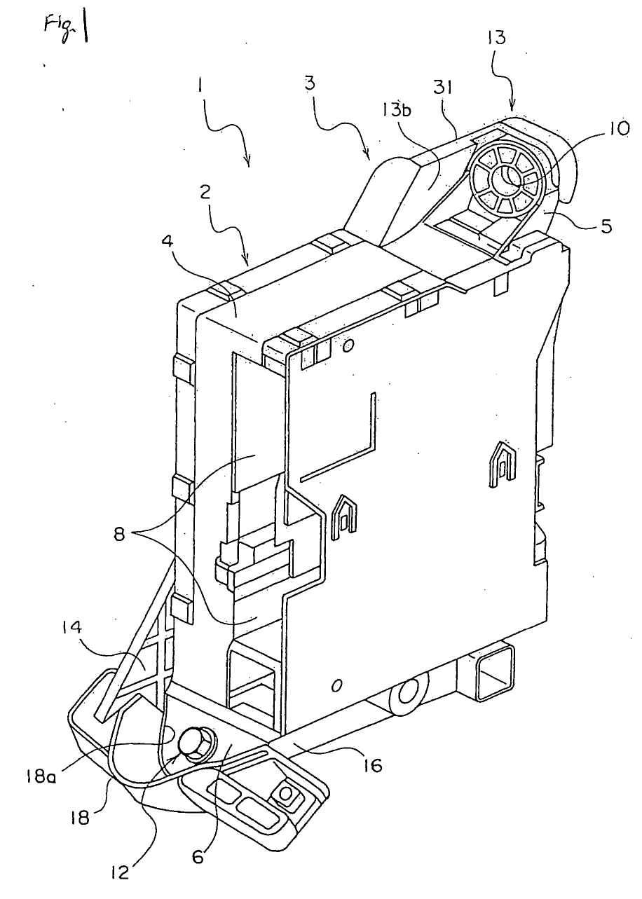

An electric connection unit, including one preferred embodiment of a holder of the present invention, will now be described with reference to FIGS. 1 to 10.

The electric connection unit 1 of this embodiment shown in FIG. 1 is mounted on an automobile serving as a mobile body. As shown in FIGS. 1 to 8, the electric connection unit 1 comprises an electric connection box 2, a small-size electric connection box (another electric connection box) 2A, and the holder 3.

The electric connection box 2 includes a flattened box-like body portion 4, fuses (electronic parts) received within the body portion 4, a distribution board received within the body portion 4, a vehicle body-mounting piece portion 5, and a holder-mounting piece portion 6. The body portion 4 has a connector portion 8 to which connectors (i.e., terminals) of a wire harness are connected. Namely, the terminals of the wire harness are connected to the electric connection box 2.

The wire harness includes a plurality of wires, and the connectors. Each of the wires is a so-called sheathed wire including a conductor (i.e., an electrically-conductive wire) and a sheath covering the conductor. The wires are connected to various electronic equipments mounted on an automobile or the like. Each connector includes metal terminals connected to distal ends of the conductors of the wires, and a connector housing of an insulative nature receiving the metal terminals therein. Namely, the connectors are mounted at the distal end portions of the wires.

The distribution board includes electrically-conductive bus bars, and insulating boards. The bus bars can be obtained by pressing or blanking an electrically-conductive metal sheet. The plurality of bus bars are arranged in a stacked manner. Each insulating board is disposed between the stacked bus bars, and prevents the short-circuiting (i.e., electrical connection) between the bus bars at regions where such electrical connection is not intended. The insulating boards also serve to locate the bus bars in their proper positions.

The distribution board, when received within the body portion 4 of the electric connection box 2, electrically connects the electric parts (such as the fuses), received within the body portion 4, to the respective wires of the wire harness in a predetermined pattern through the connectors fitted in the connector portion 8 of the body portion 4.

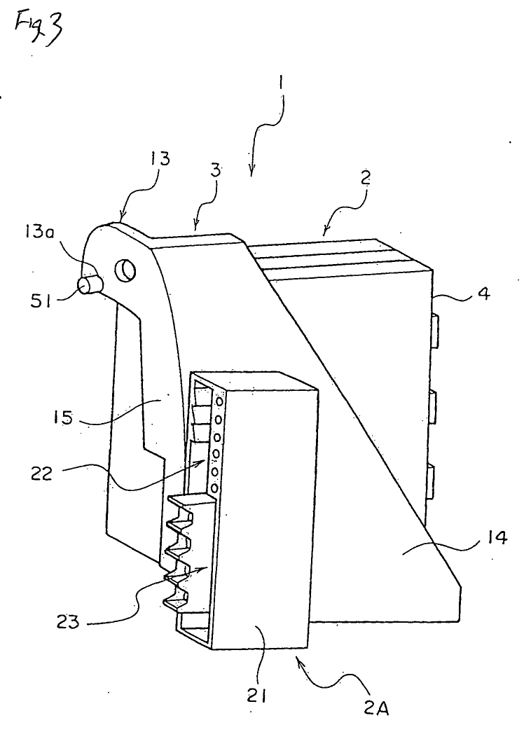

As shown in FIGS. 3 and 4, the small-size electric connection box 2A includes a flattened box-like body portion 21 smaller in size than the body portion 4 of the electric connection box 2, a relay mounting portion 22 in which relays received in the body portion 21 are mounted, a fuse mounting portion 23 in which fuses are mounted, and a connector portion 24 to which a connector of a wire harness is connected. An engagement reception portion (not shown) is formed at that side of the body portion 21 facing an interconnecting wall 14 (described later), and this engagement reception portion can be engaged with engagement portions (described later) on the interconnecting wall 14 so as to fix the body portion 21 to the interconnecting wall 14.

In this preferred embodiment, although the small-size electric connection box 2A is used as the other (or additional) electric connection box, the invention is not limited to this construction, and an electric connection box equal in size to the electric connection box 2 can be used as the additional electric connection box. In another modified form of the invention, two or more additional electric connection boxes can be mounted on the interconnecting wall 14.

The vehicle body-mounting piece portion 5 projects outwardly from one corner portion of the body portion 4 of the electric connection box 2. The vehicle body-mounting piece portion 5 has a generally flat plate-shape, and a hole 10 for the passage of a bolt therethrough is formed through a central portion thereof. The vehicle body-mounting piece portion 5 is superposed on a panel of the vehicle body of the automobile, and is mounted on this panel by the bolt passing through the hole 10 and fixed to the panel. Namely, the vehicle body-mounting piece portion 5 is used for fixing the electric connection box 2 to the vehicle body of the automobile.

The vehicle body-mounting piece portion 5 has a bar-like projecting portion 51 projecting from one side face thereof, that is, projecting outwardly of the electric connection box 2. The projecting portion 51 abuts against an abutment portion of the holder 3 (described later) to be positioned relative to the holder 3.

The holder-mounting piece portion 6 projects outwardly from another corner portion (hereinafter referred to as “the other corner portion”) of the body portion 4 of the electric connection box 2. The other corner portion of the body portion 4 of the electric connection box 2 where the holder-mounting piece portion 6 is provided and the one corner portion of the body portion 4 where the vehicle body-mounting piece portion 5 is provided are disposed on a diagonal line. The holder-mounting piece portion 6 is disposed in the vicinity of the connector portion 8 provided in the body portion 4 of the electric connection box 2. Namely, the above-mentioned other corner portion is disposed in the vicinity of the connector portion 8. Thus, the holder-mounting piece portion 6 is disposed in the vicinity of the terminals of the wires of the wire harness connected to the connector portion 8.

The holder-mounting piece portion 6 has a flat plate-shape, and a hole 11 for the passage of a bolt 12 therethrough is formed through a central portion thereof. The holder-mounting piece portion 6 is superposed on a placing wall 16 (described later) of the holder 3 serving as a placing portion, and is fixed to this placing wall 16 by the bolt 12 (serving as a fixing member) passing through the hole 11 and threaded into a nut provided in the placing wall 16. Namely, the holder-mounting piece portion 6 is used for fixing the electric connection box 2 to the holder 3.

The holder 3 includes an engagement wall 13 for engagement with the vehicle body-mounting piece portion 5, the flat plate-like interconnecting wall 14, a flat plate-like superposing wall 15 for being superposed on that portion of the electric connection box 2 disposed in the vicinity of the one corner portion thereof, the placing wall 16 (serving as the placing portion) on which the holder-mounting piece portion 6 of the electric connection box 2 is adapted to be superposed, and a vehicle body-mounting portion 17. The engagement wall 13, the interconnecting wall 14, the superposing wall 15, the placing wall 16 and the vehicle body-mounting portion 17 are formed integrally with one another, using a synthetic resin.

The engagement wall 13 serves as one positioning portion for positioning the electric connection box 2, and extends from upper edges of the interconnecting wall 14 and superposing wall 15 so as to be superposed on an upper edge portion 41 of the body portion 4 and the vehicle body-mounting piece portion 5 of the electric connection box 2. The engagement wall 13 includes a groove portion 13a against which the projecting portion 51 of the vehicle body-mounting piece portion 5 is adapted to abut, and an abutment portion 13b against which the upper edge portion 41 of the electric connection box 2 is adapted to abut.

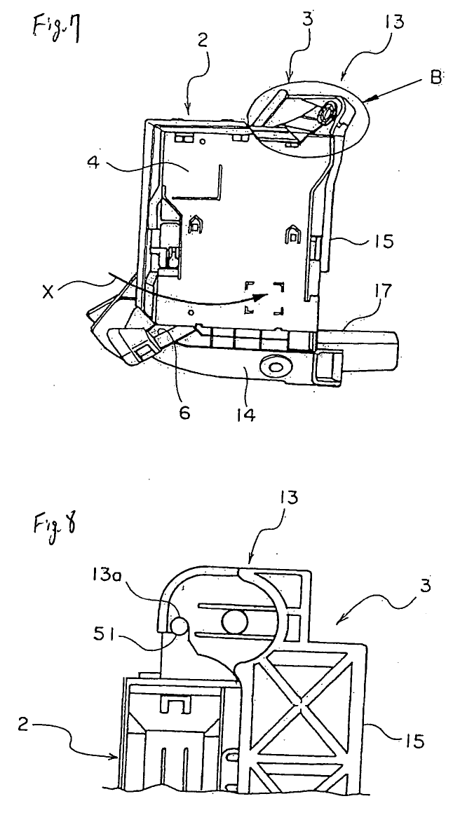

The groove portion 13a serves as a reception portion, and is defined by a recess portion of an inverted U-shaped cross-section corresponding to the cross-sectional shape of the projecting portion 51 of the vehicle body-mounting piece portion 5, as shown in FIG. 8. The projecting portion 51 can be fitted into this groove portion 13a from a lower opening thereof. The groove portion 13a is formed such that when the projecting portion 51 is fitted into the groove portion 13a, and intimately abuts against an inner surface of this groove portion 13a, an upper end portion of the vehicle body-mounting piece portion 5 intimately abuts against an inner surface of the engagement wall 13. Namely, when the intimate abutting engagement between the groove portion 13a and the projecting portion 51 and the intimate abutting engagement between the inner surface of the engagement wall 13 and the upper end portion of the vehicle body-mounting piece portion 5 are achieved, the vehicle body-mounting piece portion 5 is prevented from movement, and therefore is located in the proper position.

As shown in FIG. 6, the abutment portion 13b is defined by a convex portion of a generally sector-shape, and is formed at the inner side of the interconnecting wall 14, and projects in a predetermined range from the upper edge portion 41. The upper edge portion 41 of the body portion 4 of the electric connection box 2 has a shape corresponding to the shape of a side wall (i.e., an arc-shaped peripheral surface) 13c of the abutment portion 13b such that this upper edge portion 41, when mated with the side wall 13c, can be slid along the side wall 13c. Incidentally, it is only necessary for the abutment portion 13b to conform in contour to part of the edge portion 41 of the electric connection box 2.

The interconnecting wall 14 has a generally triangular plane shape, and interconnects the engagement wall 13 and the placing wall 16. As shown in FIG. 4, the plurality of (three in FIG. 4) engagement portions 14A and 14B for the mounting of the small-size electric connection box 2A thereon are provided at the outer side of the interconnection wall 14 facing away from the electric connection box 2. The interconnecting wall 14 can have any other suitable plane shape such for example as such a shape that the interconnecting wall 14 extends obliquely across the electric connection box 2.

The engagement portion 14A includes a plate-like engagement convex portion 141, and a pair of positioning portions 142. Each of the two engagement portions 14B includes a plate-like engagement convex portion 143 smaller in size than the engagement convex portion 141. The engagement convex portion 141 and the two engagement convex portions 143 are engaged with the engagement reception portion of the small-size electric connection box 2A, so that the small-size electric connection box 2A is attached to the outer side of the interconnecting wall 14. Incidentally, the number of the engagement portions 14A and 14B and the combination thereof can be suitably determined according to the size, weight, etc., of the small-size electric connection box 2A.

The superposing wall 15 and the placing wall 16 extends generally perpendicularly from the interconnecting wall 14. The superposing wall 15 extends perpendicularly from an outer edge of the interconnecting wall 14. The placing wall 16 serves as the other positioning portion, and extends from a corner portion of the interconnecting wall 14. The holder-mounting piece portion 6 is superposed on the placing wall 16, and the nut for being threaded on the bolt 12 is embedded in the placing wall 16, and a threaded hole of the nut communicates with the hole 11.

The vehicle body-mounting portion 17 extends outwardly from another corner portion of the interconnecting wall 14 so as to be disposed outwardly of the electric connection box 2. A bolt, passing through the panel of the vehicle body of the automobile, is threaded into the vehicle body-mounting portion 17. This bolt is thus threaded into the vehicle body-mounting portion 17, so that the holder 3 and hence the electric connection box 2 are fixed to the panel of the vehicle body of the automobile through this vehicle body-mounting portion 17.

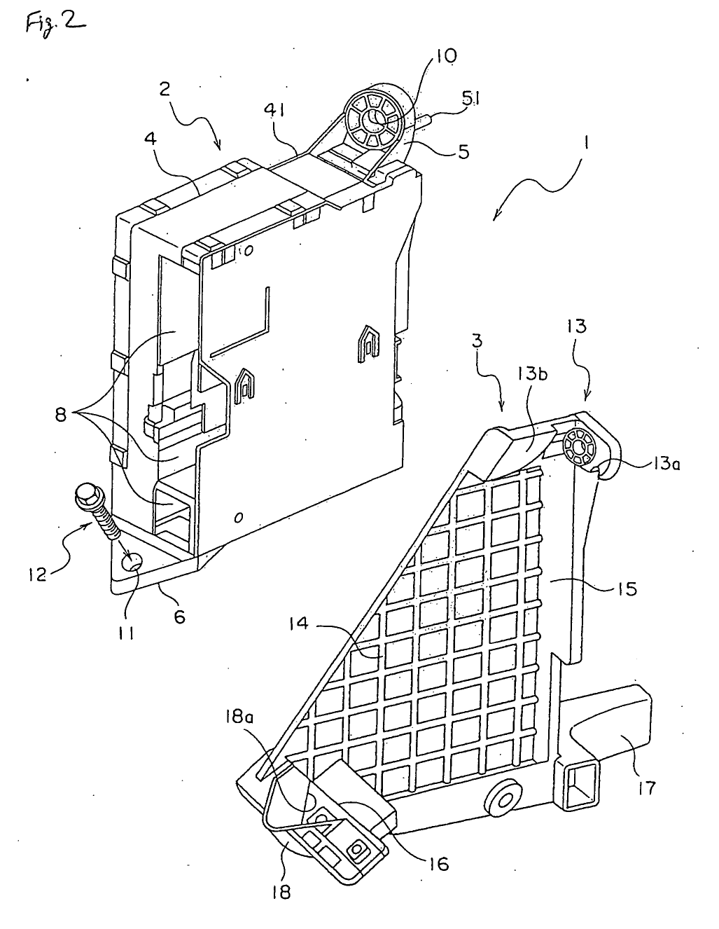

The holder 3 has a projecting piece portion 18. As shown in FIGS. 1 and 2, the wall-like projecting piece portion 18 is formed on and projects perpendicularly from an outer edge of the placing wall 16 of the holder 3. The outer shape of the projecting piece portion 18 conforms to the outer shape of the placing wall 16. The projecting piece portion 18 projects from the placing wall 16 to such an extent that it projects beyond a head of the bolt 12 (threaded in the nut) placed on the placing wall 16. Namely, a distal end or edge of the projecting piece portion 18 remote from the placing wall 16 is disposed beyond the head of the bolt 12 in a direction away from the placing wall 16 (that is, from the holder-mounting piece portion 6).

Further, a positioning portion 18a is provided at that edge of an inner surface (facing the electric connection box 2) of the projecting piece portion 18 disposed near to the placing wall 16, the positioning portion 18a conforming in contour to part (outer edge) of the holder-mounting piece portion 6. The positioning portion 18a is defined by the edge portion of the projecting piece portion 18 where the projecting piece portion 18 and the placing wall 16 are interconnected, and the outer edge of the holder-mounting piece portion 6, placed on the placing wall 16, is intimately superposed on the positioning portion 18a. Thus, the outer edge of the holder-mounting piece portion 6, placed on the placing wall 16, is intimately superposed on the positioning portion 18a, so that the positioning portion 18a properly locates the holder-mounting piece portion 6 on the placing wall 16. Namely, the positioning portion 18a positions the electric connection box 2 relative to the holder 3.

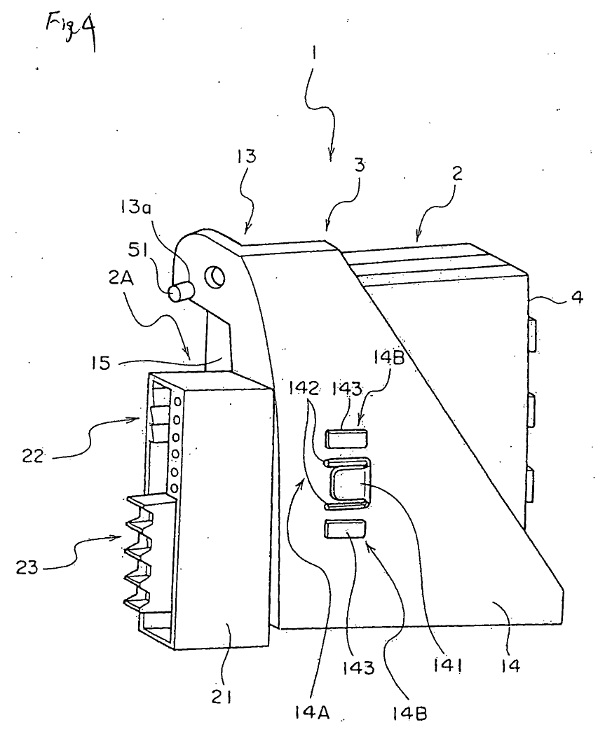

Next, a procedure of mounting the electric connection box 2 and the small-size electric connection box 2A on the holder 3 will be described with reference to FIGS. 5 to 8.

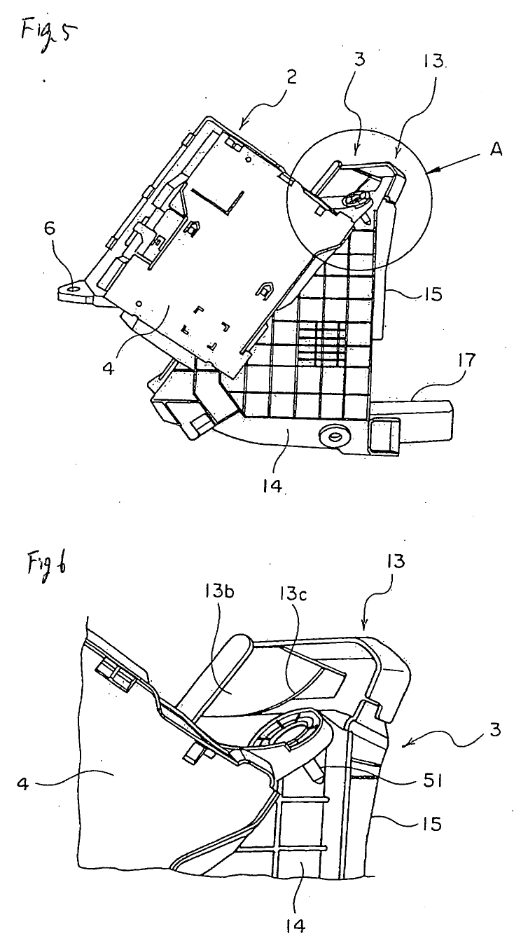

As shown in FIGS. 5 and 6, the edge portion 41 of the body portion 4 of the electric connection box 2 is brought into abutting engagement with the side wall 13c of the abutment portion 13b of the holder 3 at a predetermined angle. Then, the electric connection box 2 is slid in a sliding direction (indicated by arrow X in FIG. 7) while maintaining this abutting condition. As a result, the vehicle body-mounting portion 5 is superposed on the placing wall 15 of the holder 3 in intimately abutting relation thereto, and also the projecting portion 51 thereof intimately abuts against the groove portion 13a of the abutment wall 13 (see FIG. 8), and the holder-mounting piece portion 6 is superposed on the placing wall 16, so that the electric connection box 2 is positioned relative to the holder 3. Then, the bolt 12 is threaded into the nut, with the interconnecting wall 14 superposed on the electric connection box 2, thereby fixing the electric connection box 2 to the holder 3. The bolt is threaded into the vehicle body-mounting portion 17 of the holder 3, thereby fixing the electric connection box 2 to the panel of the vehicle body of the automobile.

The engagement reception portion of the small-size electric connection box 2A is engaged with the engagement convex portion 141 and the two engagement convex portion 143 formed on the outer side of the interconnecting wall 14 facing away from the electric connection box 2, thereby mounting the small-size electric connection box 2A on the outer side of the interconnecting wall 14. Namely, the small-size electric connection box 2A is fixed to the panel of the vehicle body of the automobile through the holder 3.

As described above, in the holder 3, the engagement wall 13 and the placing wall 16 (which serve as the two positioning portions, respectively), and the interconnecting wall 14 interconnecting the engagement wall 13 and the placing wall 16 are formed integrally with one another, using the synthetic resin. Therefore, there can be provided the positioning portions which are shaped, taking the configuration of the electric connection box 2, the position of fixing of the holder 3 to the vehicle body, etc., into consideration. Therefore, the complicated positioning portions can be formed, so that the electric connection box can be stably fixed. And besides, when the positioning portions are formed according to the kind of car, the common electric connection box 2 can be used for various cars. Furthermore, even when the positioning portions for the electric connection box 2 are formed separately from a mounting portion for mounting on the vehicle body so that the holder can be used as a mounting conversion member for mounting the electric connection box on the vehicle body, the electric connection box 2 can be stably fixed to the vehicle body.

Furthermore, the groove portion 13a and the abutment portion 13b are formed at the engagement wall 13 serving as the positioning portion, and therefore by bringing the projecting portion 51 and the edge portion 41 of the electric connection box 2 into abutting engagement respectively with the groove portion 13a and the abutment portion 13b of the holder 3, the positioning can be effected. Therefore, the operation for positioning the electric connection box 2 relative to the holder 3 can be easily carried out, so that the efficiency of the operation can be enhanced.

Furthermore, the engagement portions 14A and 14B, serving as the mounting portion on which the small-size electric connection box (i.e., the other electric connection box) 2A is mounted, are formed at the interconnecting wall 14 serving as the interconnecting portion, and therefore the small-size electric connection box 2A together with the electric connection box 2 can be mounted on the holder 3. Therefore, it is not necessary to consider the position of mounting of the small-size electric connection box 2A relative to the vehicle body, and the plurality of electric connection boxes can be fixed to the vehicle body by the holder 3.

In the above preferred embodiment, the reception portion of the positioning portion is formed by the groove portion 13a of the abutment wall 13. Another embodiment of the invention, employing a modified reception portion, will be described below with reference to FIGS. 9 to 11. Those portions of this embodiment identical or corresponding to those of the above-mentioned electric connection unit 1 will be designated by identical reference numerals, respectively, and detailed explanation thereof will be omitted.

As shown in FIG. 9, an engagement wall 13 includes a fitting hole 13d in which a projecting portion 51 of a vehicle-mounting piece portion 5 is adapted to be rotatably (or angularly movably) fitted, and an abutment portion 13b against which an upper edge portion 41 of an electric connection box 2 is adapted to abut. The fitting hole 13d serves as the reception portion of the positioning portion, and is in the form of a through hole formed through the engagement wall 13.

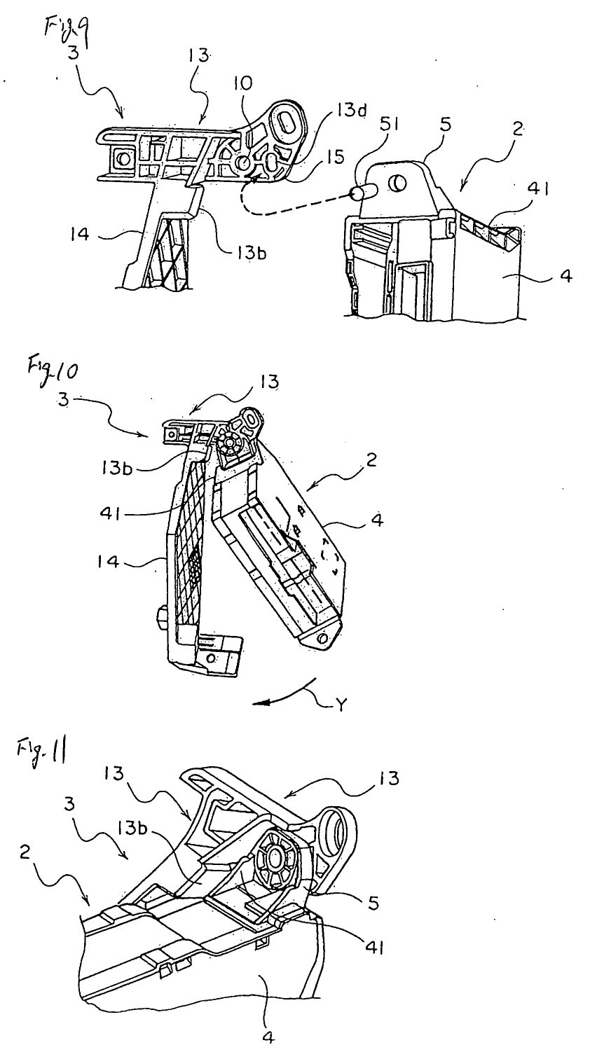

As shown in FIG. 10, the projecting portion 51 is fitted in the fitting hole 13d, so that the electric connection box 2 is supported by the engagement wall 13 so as to be angularly moved about the fitting hole 13d, and is positioned in a direction of a width of an interconnecting wall 14. Then, the electric connection box 2 is angularly moved in an angularly-moving direction (indicated by arrow Y in FIG. 10), so that the edge portion 41 of a body portion 4 of the electric connection box 2 is brought into abutting engagement with the abutment portion 13b of a holder 3, thereby preventing the angular movement of the electric connection box 2 as shown in FIG. 11.

Namely, the vehicle body-mounting portion 5 is superposed on a placing wall 15 of the holder 3 in intimately abutting relation thereto, and also the abutment portion 13b intimately abuts against the edge portion 41 of the body portion 4 of the electric connection box 2, and a holder-mounting piece portion 6 of the holder 3 is superposed on a placing wall 16, so that the electric connection box 2 is positioned relative to the holder 3. Then, a bolt 12 is threaded into a nut, with the interconnecting wall 14 superposed on the electric connection box 2, thereby fixing the electric connection box 2 to the holder 3. A bolt is threaded into a vehicle body-mounting portion 17 of the holder 3, thereby fixing the electric connection box 2 to the panel of the vehicle body of the automobile.

With this construction of the positioning portions of the holder 3, also, the complicated positioning portions can be formed, and therefore the electric connection box 2 can be stably fixed. And besides, when the positioning portions are formed according to the kind of car, the common electric connection box 2 can be used for various cars. Furthermore, even when the positioning portions for the electric connection box 2 are formed separately from amounting portion for mounting on the vehicle body so that the holder can be used as a mounting conversion member for mounting the electric connection box on the vehicle body, the electric connection box 2 can be stably fixed to the vehicle body.

Furthermore, the fitting hole 13d and the abutment portion 13b are formed at the engagement wall 13 serving as the positioning portion, and therefore by bringing the projecting portion 51 and the edge portion 41 of the electric connection box 2 into abutting engagement respectively with the fitting hole 13d and the abutment portion 13b of the holder 3, the positioning can be effected. Therefore, the operation for positioning the electric connection box 2 relative to the holder 3 can be easily carried out, so that the efficiency of the operation can be enhanced.

The above embodiments are merely representative ones of the invention, and the invention is not limited to these embodiments, and various modifications can be made without departing from the subject matter of the invention. Namely, each of the positioning portions can take any other suitable form in so far as the positioning portions can position the electric connection box 2.

What is claimed is:

1. A holder for holding an electric connection box and for fixing said electric connection box to a vehicle body, comprising:
at least two positioning portions for positioning said electric connection box; and
an interconnecting portion interconnecting said two positioning portions; and
wherein said two positioning portions and said interconnecting portion are formed integrally with one another, using a synthetic resin.

2. A holder according to claim 1, wherein said positioning portion includes a reception portion against which a projecting portion projecting from said electric connection box is adapted to abut, and an abutment portion against which an edge portion of said electric connection box is adapted to abut.

3. The holder according to claim 1, wherein said interconnecting portion has a mounting portion to which another electric connection box is attached.
